(19) United States
(12) Patent Application Publication
(10) Pub. No.: US 2009/0019776 A1
(43) Pub. Date: Jan. 22, 2009

(54) CABLE GUIDE AND SLIDING DOOR DRIVE MECHANISM USING THE SAME

(76) Inventors: Takashi OHTAKI, Hyogo (JP); Chiharu Azuma, Hyogo (JP); Shunsuke Takami, Hyogo (JP)

Correspondence Address: BROWDY AND NEIMARK, P.L.L.C.;624 NINTH STREET, NW, SUITE 300, WASHINGTON, DC, 20001-5303, US

(21) Appl. No.: 12/177,065

(22) Filed: Jul. 21, 2008

(30) Foreign Application Priority Data
Jul. 20, 2007 (JP) 2007-189787

(51) Int. Cl. E05F 11/06; E05F 15/14

(52) U.S. Cl. 49/360; 49/213

(57) ABSTRACT

The present invention provides a cable guide for changing direction of an inner cable for operating a sliding door of a car, comprising a pulley casing having a box shape with an opening at its top and a guide recess at an inner side of its bottom, a slider provided with a sliding plate slidably guided by means of the guide recess of the pulley casing and a shaft extending upward from a top of the sliding plate, a pulley rotatably supported by the shaft of the slider, an urging member urging the slider along the guide recess toward a direction for giving tension to the inner cable, and a casing cover covering the opening of the pulley casing, and being configured so that an inner side of the casing cover and a top face of the shaft are slidable each other.

### BACKGROUND OF THE INVENTION

1. Field of the Invention

The present invention relates to cable guides for changing direction of inner cables and to sliding door driving mechanisms using the cable guide, and more specifically to a cable guide for sliding a sliding door of a vehicle such as a car or a small boat and to a sliding door driving mechanism using the cable guide.

2. Description of the Related Art

Patent Document 1: JP 55-161173 A

Patent Document 2: JP 2005-273308 A

Patent Document 3: JP 9-256732 A

FIG. 10 shows a pulley for use in a window regulator described in the patent document 1. A pulley 101 of the window regulator shown in FIG. 10 is arranged at a top (or a bottom) of a vertically-extending guide rail 102. The guide rail 102 has on its top a rack 102a, on which a bearing block 103 is disposed. The bearing block 103 includes teeth. The block 103 is movable upward along the guide rail 102, but the block 103 is prevented from moving downward as the teeth engage with teeth of the rack 102a. Thus, the bearing block 103 having once moved upward never moves back downward. There is provided a shaft 107 rotatably supporting the pulley 101, the shaft 107 having a proximal end secured to a side (upper face in the figure) of the bearing block 103.

There is provided a bracket 104 extending from the guide rail 102 so as to cover a side (upper face in the figure) of the pulley 101. The bracket 104 has an elongated hole 104a, through which a distal end of the shaft 107 rotatably supporting the pulley 101 projects. The projecting distal end of the shaft 107 is movable along the elongated hole 104a. The bearing block 103 is urged upward by a spring 106. An inner cable 105 is looped around the pulley 101, so that a tensional force caused by the inner cable 105 normally balances with an urging force caused by the spring 106. When the inner cable 105 loosens, the urging force by the spring 106 becomes beyond the tensional force, allowing the bearing block 103 to move upward along with the pulley 101. In consequence, the inner cable 105 is tensioned again.

Though not shown herein, the patent document 2 discloses a pulley and a loosening-absorption mechanism (tension adjusting mechanism) of an inner cable used for opening and closing a sliding door of a car body. Also in this arrangement, a shaft of a pulley is guided through a slot (elongated hole) formed in a casing.

Further, though not shown herein, the patent document 3 discloses a tension adjusting device that is arranged on a cable driving means of a sliding door. This device is designed to apply tension to an inner cable by pressing tension pulleys against the inner cable immediately before being wound to a drum and being unwound therefrom by urging forces caused by coil springs.

### SUMMARY OF THE INVENTION

### Problems to be Solved by the Invention

In the device of the patent document 1, the pulley 101 configured to change direction of the inner cable is arranged apart in a thickness direction from the bearing block 103 and the spring 106, which are configured to move the pulley 101. Therefore, the device takes up much space, resulting in difficulty in installing the device in a car body. Further, the proximal shaft end is secured to the bearing block 103, whereas the distal shaft end projects from the elongated hole of the bracket so as to be movable along the elongated hole, resulting in lack of stability.

In the device of the patent document 2 as well, the shaft of the pulley is slidably engaged with the slot formed in the casing. This arrangement increases thickness of the casing by just the projecting shaft much and might lack reliable slidability of the pulley because the shaft slides engaging with the slot. The device of the patent document 3 as well has a shaft end projecting from the cable driving means and is designed to support the projecting portion from its side.

The mechanisms for holding a pulley described in the above-mentioned patent documents each have a shaft end projecting from a base or a casing and are configured to support the shaft from its side. In such holding, it is mostly necessary to have a certain thickness of a member such as a base or a casing from which the shaft projects in order to surely hold the shaft. In other words, in order to hold the shaft from its side without relative displacement, the shaft needs to be held by the base having a certain vertical thickness. For example, when the shaft is held by a thin base member, it is difficult to prevent the shaft from relative displacement because a portion for holding the shaft is vertically thin. Thus, in order to achieve a stable holding, it is necessary to project the shaft through a throughhole having a certain length in a thickness direction of the member.

However, it has many advantages, such as easy assembly and less potential interference with other members, to design a device as thin as possible, because a pulley of a sliding door is arranged between an outer panel and an inner panel of a side of a car body. In this way, construction of members around a pulley thinly and with saving space contradicts a reliable support of the shaft with sliding the pulley.

It is therefore an object of the present invention to provide a cable guide configured to ensure support of a pulley with a simple structure.

Means to Solve the Problem

The present invention provides a cable guide (claim 1) for changing direction of an inner cable for operating a sliding door of a car, comprising a pulley casing having a box shape with an opening at its top and a guide recess at an inner side of its bottom, a slider provided with a sliding plate slidably guided by means of the guide recess of the pulley casing and a shaft extending upward from a top of the sliding plate, a pulley rotatably supported by the shaft of the slider, an urging member urging the slider along the guide recess toward a direction for giving tension to the inner cable, and a casing cover covering the opening of the pulley casing, and being configured so that an inner side of the casing cover and a top face of the shaft are slidable each other. (Herein, the term “recess” includes a groove.)

In such the cable guide, it is preferable that the sliding plate has a convex portion curved upward and formed adjacent to the center thereof, the shaft having a lower end projecting to a lower side of the convex portion, so that the shaft is secured to the slider (claim 2). Further, the shaft preferably has a flange formed at its top (claim 3). Further, the casing cover preferably has a cover guide recess formed on an inner face thereof so that the flange of the shaft is slidably guided by the cover guide recess (claim 4). Further, the sliding plate preferably has a stopper for preventing the inner cable from slipping out, the stopper extending from the plate to come close to an outer circumference of the pulley (claim 5).

The present invention provides a sliding door drive mechanism (claim 6) comprising the cable guide as described above, an inner cable for operating a sliding door of a car by being changed in direction by means of the cable guide, a drum for winding and unwinding the inner cable, and a driving motor for driving rotation of the drum via a reducer.

ADVANTAGEOUS EFFECT OF THE INVENTION

The cable guide (claim 1) of the present invention allows sliding of the slider with maintaining rotation of the pulley because the slider slides along the guide recess with the shaft secured to the slider, achieving reliable operation. Further, it is possible to prevent the shaft from tilting by means of the casing cover because the top face of the shaft slides on the inner side of the casing cover.

In such the cable guide, when the shaft is secured to the slider with the lower end of the shaft projecting to the lower side of the convex portion, which is formed adjacent to the center of the sliding plate and curved upward (claim 2), the shaft is strongly secured because the lower end of the shaft projects to the lower side of the convex portion. Further, the slider smoothly slides because a sliding area between the slider and the guide recess is decreased by just an area of the convex portion.

When the flange is formed on the top of the shaft (claim 3), the flange protects the pulley from disengaging from the distal end of the shaft and further prevents the shaft from tilting with maintaining rotation of the pulley because the flange slides on the inner side of the casing cover. That achieves assurance of operation.

When the casing cover has the cover guide recess formed on then inner face thereof so that the flange of the shaft is slidably guided by the cover guide recess (claim 4), reliable operation is further increased.

When the sliding plate has the stopper for preventing the inner cable from slipping out and the stopper extends from the plate to come close to the outer circumference of the pulley (claim 5), reliable operation is ensured even when sliding of the slider generates a gap between the side of the pulley casing and the outer circumference of the pulley because the stopper prevents the inner cable from slipping out.

The sliding door drive mechanism (claim 6) of the present invention dispenses with a tension applying device for an inner cable adjacent to the drum because the cable guide as described above applies tension to the inner cable. That achieves space-saving and weight-saving.

### BRIEF DESCRIPTION OF THE DRAWINGS

FIG. 1 is an exploded perspective view of one embodiment of a cable guide of the present invention;

FIG. 2 is a fragmentary schematic perspective view of a car body in which the cable guide in FIG. 1 is used;

FIG. 3 is a schematic diagram showing arrangement of a cable of a power sliding door unit provided with the cable guide in FIG. 1;

FIG. 4A is a cross section taken along a line A-A in FIG. 1, FIG. 4B being a cross section taken along a line B-B in FIG. 1, and FIG. 4C being a cross section taken along a line C-C in FIG. 1;

FIG. 5 is a back elevation of a casing cover in FIG. 1;

FIG. 6 is a cross section of a front cable guide in FIG. 3;

FIGS. 7A and 7B show another embodiment of a cable guide, FIG. 7A being a top view thereof, and FIG. 7B being a side cross section thereof;

FIGS. 8A and 8B show still another embodiment of a cable guide, FIG. 8A being a top view thereof, and FIG. 8B being a side cross section thereof;

FIGS. 9A and 9B show yet another embodiment of a cable guide, FIG. 9A being a top view thereof, and FIG. 9B being a side cross section thereof; and

FIG. 10 is a schematic diagram showing a mechanism in the related art.

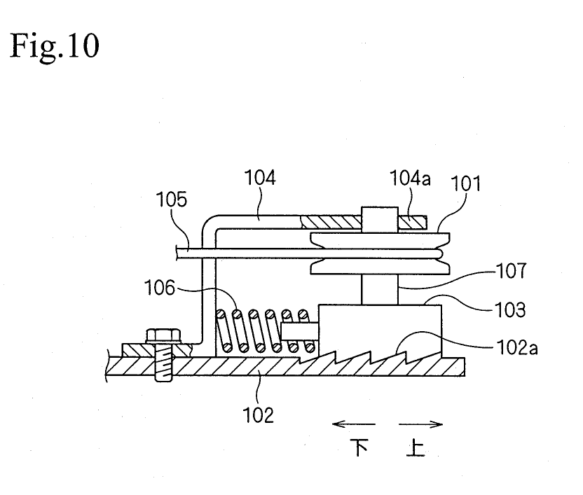

### BEST MODE FOR CARRYING OUT THE INVENTION

Now, embodiments of a cable guide of the present invention will be described in detail below, making reference to the accompanying drawings.

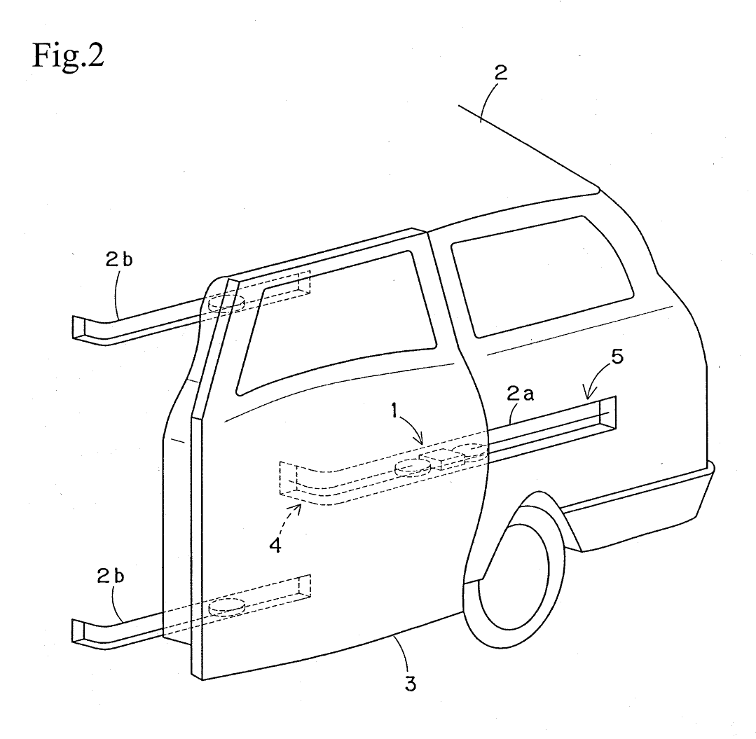

First, referring to FIG. 2, a power sliding door unit 1 in which a cable guide of the present invention is used will be described below. The unit 1 shown in FIG. 2 is used in a car body 2 of a minivan type, for example. There is provided a door 3 at a side of the car body 2. The door 3 slides along rails, a center rail 2a located in the center of the car body 2 and rails 2b and 2b located at the top and the bottom parts thereof.

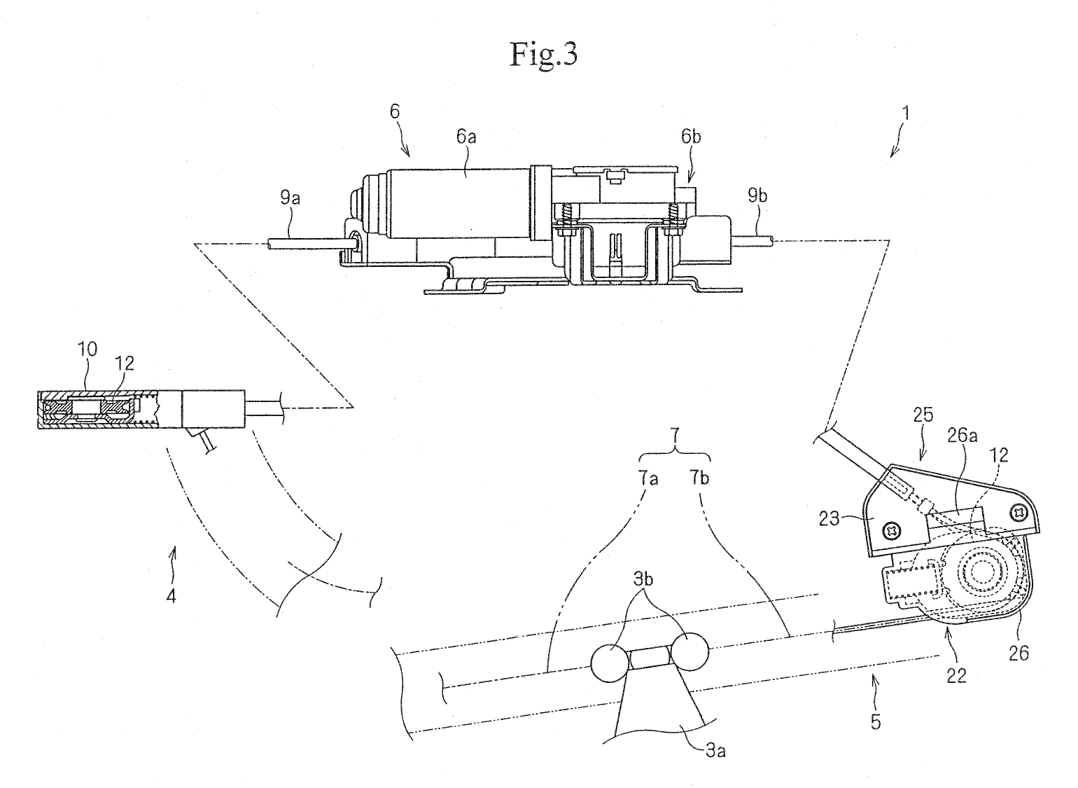

From now, also referring to FIG. 3, the more detail will be described. The unit 1 shown in FIG. 3 is arranged adjacent to the center rail 2a located adjacent to the center of the car body 2. The center rail 2a has a portion 4 near its anterior end bent toward a car interior and another portion 5 near its posterior end extending straight. The center rail 2a supports an arm 3a for attaching the door 3. The arm 3a is slidably arranged between the anterior and posterior ends of the rail 2a. The arm 3a is attached with rollers 3b, 3b rollably, which are configured to roll within the center rail 2a. The arm 3a is attached with an end of an inner cable 7a for moving the door 3 forward and an end of an inner cable 7b for moving the door 3 backward, respectively. The inner cables 7 (7a and 7b) extend along the center rail 2a at outside of the car body 2.

There is also provided a front cable guide 10 for changing direction of the cable, the cable guide 10 being attached to an outer wall of the car body near the portion 4 of the center rail 2a. The front cable guide 10 has a pulley 12 supported rotatably thereto such that its rotational axis is brought in line with a horizontal (right-left) direction of the car body. The inner cable 7a is introduced into the car body through an opening formed at the outer wall of the car body, being changed in direction by means of the pulley 12, and then being guided to a driving section 6 via a front outer casing 9a. On the other hand, there is provided a rear cable guide 25 at the portion 5 of the center rails 2a. The rear cable guide 25 has another pulley 12 supported rotatably thereto such that its rotational axis is brought in line with a vertical direction. The inner cable 7b is introduced into the car body through an opening formed at the outer wall of the car body, being changed in direction by means of the pulley 12, and then being guided to the driving section 6 via a rear outer casing 9b.

The above-mentioned driving section 6 includes: (1) a drum (not shown) for reciprocating and circulating a loop of the inner cable by winding and rewinding the other ends of the inner cables 7; (2) a motor 6a for rotating the drum; (3) a clutch (not shown) for transmitting the driving force and annulling the transmittance between the drum and the motor 6a; and (4) a reducer 6b. In this embodiment, the driving section 6 is arranged such that its output axis is brought in line with a horizontal (right-left) direction of the car body. The driving section 6 and the outer casings 9a and 9b are housed within a panel of a side wall of the car. The description hereafter will designate the front of the car body as a front and the rear of the car body as a rear.

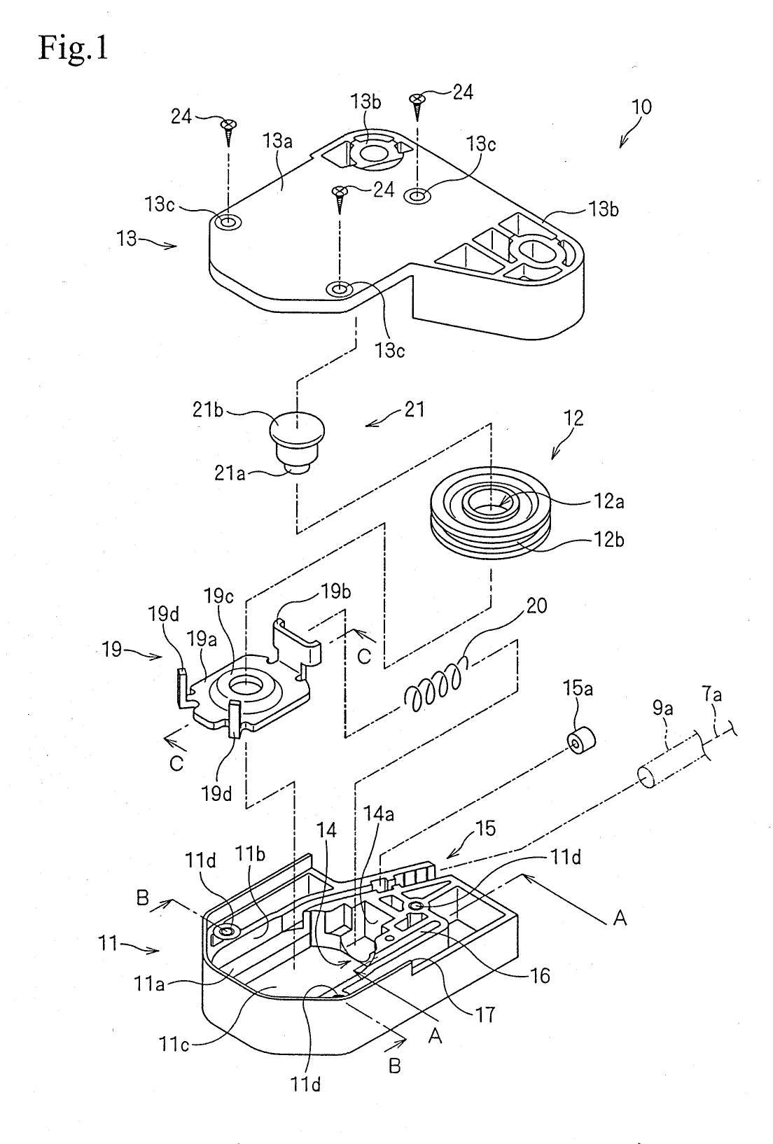

The front cable guide 10 shown in FIG. 1 includes a pulley casing 11, a slider 19 slidably arranged within the pulley casing 11, a pulley 12 rotatably supported on the slider 19, an urging member (spring) 20, and a casing cover 13 covering an upper face of the pulley casing 11. The urging member 20 urges the slider 19 in a direction applying tension to the inner cable 7a, that is, in a direction substantially opposite to an extending direction of the inner cable 7a.

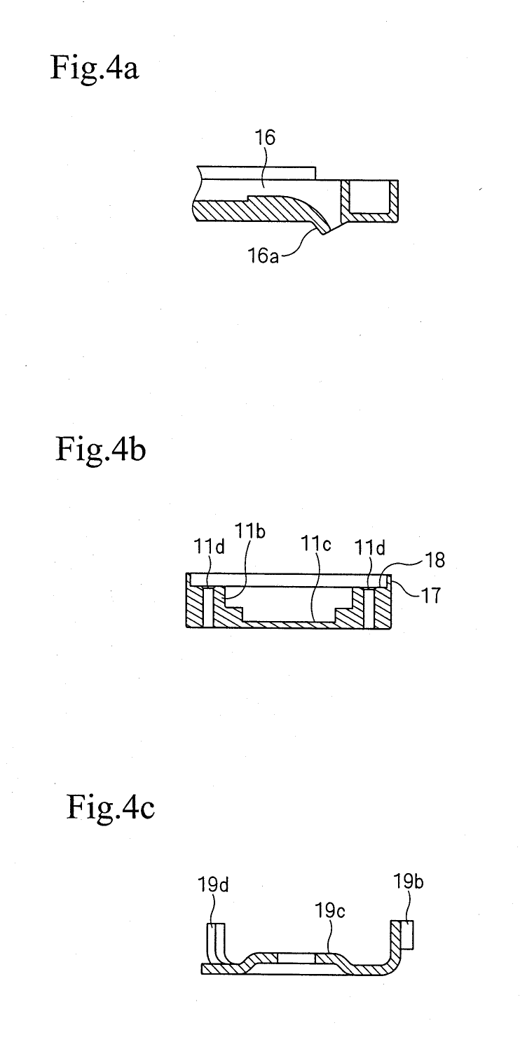

As shown in FIG. 1, the pulley casing 11 includes a bottom face 11a and a standing wall 11b standing from an edge of the bottom face 11a. The bottom face 11a has a casing guide recess 11c for guiding a forward and back movement of the slider 19 (see FIG. 4b). The standing wall 11b stands around the bottom face 11a in a racetrack shape viewed as a whole. More specifically, the wall 11b curves semicircularly adjacent to anterior and posterior ends of the casing in such a manner as following an outer circumference of the pulley 12 and is parallel to the casing guide recess 11c near the center. The standing wall 11d has at its outer side three joint holes 11d, 11d, and 11d.

Further, a spring housing 14 for housing a spring 20 is formed at the posterior end (at a right side in the figure) of the casing guide recess 11c and contiguously with the bottom face 11a with the standing wall 11b partly cut out. The spring 20 is attached to a wall 14a of a posterior end of the spring housing 14 at one end of the spring 20 and to the slider 19 at the other end thereof. Further, the spring housing 14 has side walls guiding the spring 20 to smoothly extend and contract.

There is provided a fixing portion 15 formed behind the standing wall 11b or over the spring housing 14. The fixing portion 15, which penetrates through the standing wall 11b, is configured to guide the inner cable 7a from the driving section 6 (see FIG. 3) and to fix an end of the front outer casing 9a.

Further, there is provided a receptacle for receiving therein a tubular elastic member 15a between the fixing portion and the standing wall 11b. The inner cable 7a extends through the member 15a with the cable 7a elastically introduced into the member 15a from the front outer casing 9a. The elastic member 15a protects interior of the pulley casing 11 from dust and water. The elastic member 15a is preferably made of rubber, rubber resin, or elastomer, and more preferably of silicon rubber.

There is provided a guideway 16 penetrating through the standing wall 11b below the fixing portion 15, across the spring housing 14, and substantially in parallel to the fixing portion 15. The guideway 16 guides the inner cable 7a having been changed in direction by means of the pulley 12 in a direction toward the outside of the car. The guideway 16 has a protruding portion 16a formed by a distal end of the guideway 16 extending in a gradual backward curve (curved towards the bottom face 11a) toward the outside of the car (see FIG. 4a).

Each part of the pulley casing 11, including the standing wall 11b, the fixing portion 15, the guideway 16 and its vicinity, the spring housing 14 and its vicinity, and the joint holes 11d, 11d, 11d and their vicinities, has a top face 18 formed flush with one another. A peripheral wall 17 stands upward from the flush-formed face 18 (see FIG. 4b) and along a peripheral edge of the pulley casing 11. The extending peripheral wall 17 makes the face 18 seem just like a step portion. The pulley casing 11 is preferably integrally formed by synthetic resin or the like. The synthetic resin preferably includes polyester, polyamide (PA), polyoxymethylene (POM), and more preferably polybutylene terephthalate (PBT).

As shown in FIG. 1, the casing cover 13 includes a lid (main body) 13a and attaching portions 13b and 13b extending vertically from the lid 13a. The casing cover 13 covers an upper part of the bottom face 11a, the fixing portion 15, the guideway 16, and the spring housing 14 of the pulley casing 11. The lid 13a has three holes 13c, 13c, and 13c at positions corresponding to the joint holes 11d, 11d, and 11d of the pulley casing 11, respectively. The lid 13a is engaged with the pulley casing 11 along an inner periphery of the peripheral wall 17 (see FIG. 4b) of the pulley casing 11, thereby ensuring easy assembly. With a face of an inner side of the casing cover 13 fitly brought into contact with the face 18 of the pulley casing 11, the casing cover 13 and the pulley casing 11 are closed with fasteners 24 such as screws, which extend through the holes 13c, 13c, and 13c of the lid 13a into the joint holes 11d, 11d, and 11d of the pulley casing 11.

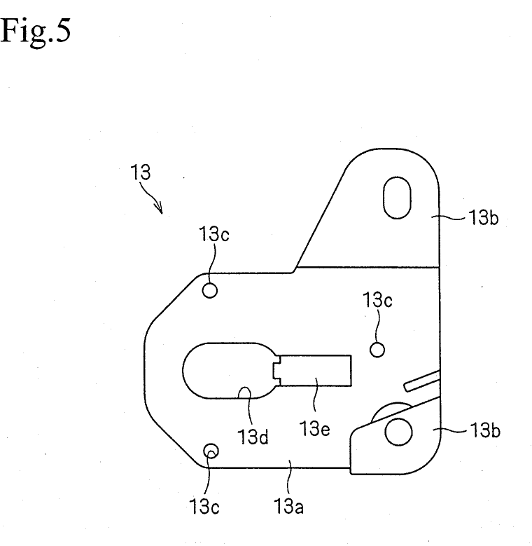

As shown in FIG. 5, the lid 13a of the casing cover 13 has a cover guide recess 13d formed adjacent to the center of the inner side thereof. A semicircular groove 13e is formed on the back of a rear end of the cover guide recess 13d and above the spring 20, having a substantially semicircular cross sectional shape along an outer periphery of an upper half of the spring 20. The semicircular groove 13e is united with the spring housing 14 of the pulley casing 11 (see FIG. 1), so as to form a cavity having a circular cross sectional shape and for housing the spring 20. The cavity guides the spring 20 to extend and contract. In the present embodiment, a compression coil spring is used as the spring 20.

The casing cover 13 is preferably made of polyester, polyamide (PA), or polyoxymethylene (POM), and more preferably of polybutylene terephthalate (PBT).

As shown in FIG. 1, the slider 19 is formed by bending a plate-like member and mainly consists of a sliding plate 19a and a spring engaging part 19b. The sliding plate 19a is configured to be slidably guided by the casing guide recess 11c of the pulley casing 11. The spring engaging part 19b vertically extends from a rear end of the sliding plate 19a and is configured to secure the end of the spring 20 thereto. The slider 19 further includes a convex portion (boss section) 19c banking upward in a bowl shape and being formed adjacent to the center of the sliding plate 19a. A shaft 21 is fixed to the boss section 19c. The slider 19 further has stoppers 19d and 19d vertically extending from an anterior edge thereof. A gap between each of the stoppers 19d, 19d and an outer circumference of the pulley 12 is smaller than a diameter of the inner cable 7a, so as to prevent the inner cable 7a from slipping from the pulley 12.

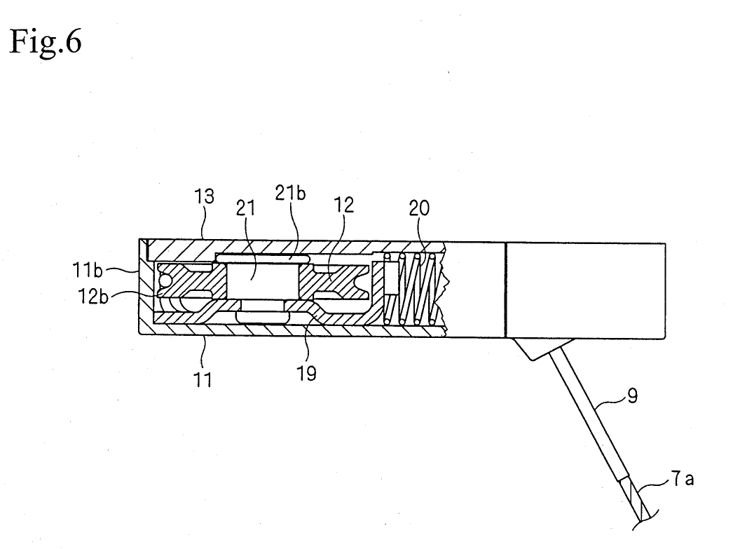

The shaft 21 includes a small diameter part 21a to be fitted in the boss section 19c at a bottom thereof and a flange 21b extending outward from a top of the shaft. As shown in FIG. 6, the small diameter part 21a of the shaft 21 extends through and projects downward from the boss section 19c to be engaged with the section 19c. The portion projecting therefrom comes inside the curved portion of the boss section 19, being kept from coming in contact with the bottom face 11a of the pulley casing 11. That allows sliding of the slider 19. The shaft 21 is stably secured because the shaft 21 is supported at a portion slightly above the bottom of the shaft 21. Further, the flange 21b of the shaft 21 comes on the top face of the pulley 12, so as to function as a retainer for bringing down the top face of the pulley 12. The shaft 21 is slidably guided by means of the cover guide recess 13d of the casing cover 13. The cover guide recess 13d guides the wide flange 21b, so as to allow the slider 19 to stably slide.

Referring to FIG. 1, the pulley 12 has an opening 12a in its center so as to be rotatably supported by a main body of the shaft 21 and a guide groove 12b adjacent to a center of its cylindrical side so as to guide the inner cable 7a. The opening 12a through which the pulley 12 is supported by the shaft 21 has a tubular shape with its periphery raised, top and bottom end faces of the tubular shape being slidably sandwiched between the sliding plate 19a of the slider 19 and a rear side of the flange 21b of the shaft 21. In this way, a sliding area between the pulley 12 and the slider 19 is so small that a stable rotation of the pulley 12 is maintained. Further, a gap between the outer circumference of the pulley 12 and the vicinity of the center of the standing wall 11b of the pulley casing 11 (a portion in parallel with the casing guide recess 11c) is smaller than the diameter of the inner cable 7a, so as to prevent the inner cable 7a from slipping from the guide groove 12. Herein, as described above, between the front portion of the standing wall 11b and the pulley 12, the inner cable 7a is prevented from slipping from the guide groove 12b by means of the stoppers 19d and 19d of the slider 19. The pulley 12 is preferably made of polyoxymethylene (POM), polyester, or polyamide (PA), but more preferably of polyoxymethylene (POM).

It is possible to keep water and dust from outside the car out of the pulley casing 11 by a grommet attached to a flange formed on the protruding portion 16a (see FIG. 4a) of the pulley casing 11 in such a manner as covering an outer periphery of the protruding portion 16a. The grommet is preferably made of rubber or rubber resin, but more preferably of chloroprene rubber (CR).

As shown in FIG. 6, the pulley 12 applies tension to the inner cable 7a and removes the loosening thereof by urging the slider 19 forward (to the left side in FIG. 6) by means of the spring 20. FIG. 6 shows the pulley 12 urged by the spring 20 to be arranged at the anterior end of the pulley casing 11. When the inner cable 7a is yet prolonged, there is a wide gap between the outer circumference of the pulley 12 and the front portion of the standing wall 11b of the pulley casing 11. However, the inner cable 7a is prevented from slipping from the guide groove 12b because the stoppers 19d and 19d (see FIG. 1) of the slider 19 are arranged adjacent to the outer circumference of the pulley 12.

FIG. 3 shows the rear cable guide 25. Since the rear cable guide 25 has components similar to the front cable guide 10 described above, the same numerals are assigned to the similar components, and description thereof is omitted. The rear cable guide 25 includes a pulley casing 26, the pulley 12 rotatably supported in the pulley casing 26, and a casing cover 23 for covering the top face of the pulley 12.

The pulley casing 26 has a guide hole 22 leading to outside of the car body 2, the hole 22 being formed through the standing wall 11b (see FIG. 1) of the casing 26. The inner cable 7b for moving the door 3 backward introduced into the fixing portion 15 is changed in direction by means of the pulley 12, and then extending outside through the guide hole 22 formed on the standing wall 11b. The pulley casing 26 further has at its rear side a bracket 26a extending in a direction perpendicular to the figure, the bracket 26a being a part to be attached to the car body. There is also provided a bracket 23b extending outward at an outer face of the casing cover 23.

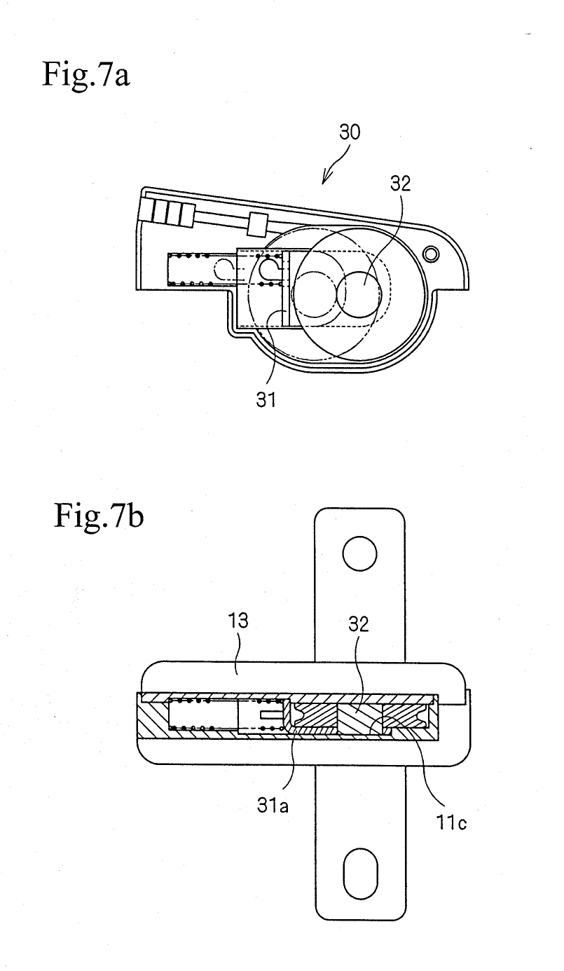

FIGS. 7A to 9B show other embodiments of the cable guide. In FIGS. 7A, 8A, and 9A each, the casing cover is removed so as to show inside of the cable guide. Imaginary lines in the figures show positions of the pulleys 12 and sliders 31 and 42 when springs 20 and 51 are most compressed. Since a cable guide 30 shown in FIGS. 7A and 7B has components similar to the front cable guide 10 described above, the same numerals are assigned to the similar components, and description thereof is omitted. In the cable guide 30, a sliding plate 31a of the slider 31 dispenses with such a boss section as that 19c of the slider 19 of the cable guide 10. Therefore, a bottom face of a shaft 32 is formed flush with a bottom face of the slider 31 without projecting the bottom of the shaft 32 downward of the sliding plate 31a of the slider 31. Both the faces formed flush with each other are configured to slide on the top face of the casing guide recess 11c. Meanwhile, the shaft 32 dispenses with such a flange as that 2b of the shaft 21 at its top. Therefore, the top of the shaft 32 slightly projects upward from the top face of the pulley 12, so that the shaft 32 slides on the bottom face of the cover guide recess 13d. In this embodiment, the cable guide may be formed thinner.

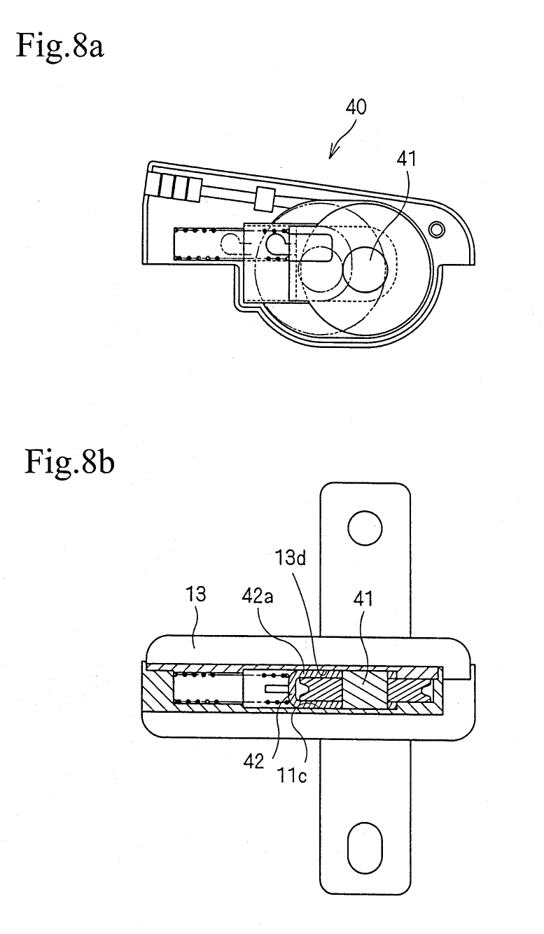

A cable guide 40 shown in FIG. 8A and 8B includes the slider 42 in which a top of a shaft 41 is also rotatably supported on a sliding plate 42a. That ensures support of the shaft 41, having little influence on rotation of the pulley 12 even when the slider 42 slides.

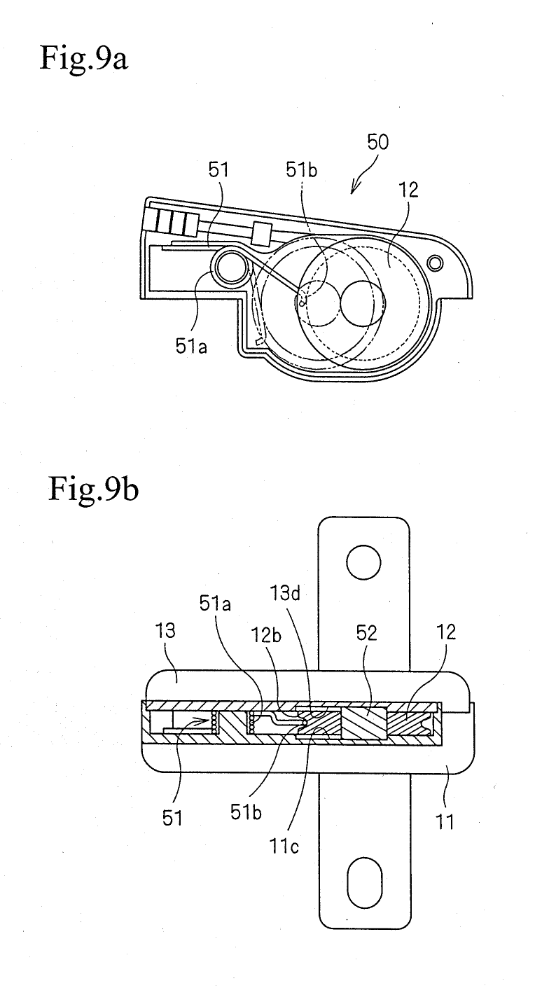

A cable guide 50 shown in FIG. 9A and 9B dispenses with a sliding plate and uses a shaft 52 as a sliding member. The spring 51 directly urges the pulley 12. A tip 51b extending from a coiled part 51a of the spring 51 is engaged with the guide groove 12b of the pulley 12, around which the inner cable 7b is wound, at a position where the tip 51b does not obstruct the inner cable 7b. Upon rotation of the pulley 12, the tip 51b slides in the guide groove 12b. The pulley 12 is united with the shaft 52. Top and bottom end faces of the shaft 52 slide in the cover guide recess 13d of the casing cover 13 and in the casing cover guide recess 11c of the pulley casing 11, respectively. Herein, the pulley 12 may be rotatably supported by the shaft 52.

1. A cable guide for changing direction of an inner cable for operating a sliding door of a car, comprising:
a pulley casing having a box shape with an opening at its top and a guide recess at an inner side of its bottom;
a slider provided with a sliding plate slidably guided by means of the guide recess of the pulley casing and a shaft extending upward from a top of the sliding plate;
a pulley rotatably supported by the shaft of the slider;
an urging member urging the slider along the guide recess toward a direction for giving tension to the inner cable; and
a casing cover covering the opening of the pulley casing, and
being configured so that an inner side of the casing cover and a top face of the shaft are slidable each other.

2. The cable guide as defined in claim 1,
the sliding plate having a convex portion curved upward and formed adjacent to the center of the plate, the shaft having a lower end projecting to a lower side of the convex portion,
so that the shaft is secured to the slider.

3. The cable guide as defined in claim 1,
the shaft having a flange formed at its top.

4. The cable guide as defined in claim 2,
the shaft having a flange formed at its top.

5. The cable guide as defined in claim 3,
the casing cover having a cover guide recess formed on an inner face thereof,
so that the flange of the shaft is slidably guided by the cover guide recess.

6. The cable guide as defined in claim 4,
the casing cover having a cover guide recess formed on an inner face thereof,
so that the flange of the shaft is slidably guided by the cover guide recess.

7. The cable guide as defined in claim 1,
the sliding plate having a stopper for preventing the inner cable from slipping out, the stopper extending from the plate to come close to an outer circumference of the pulley.

8. The cable guide as defined in claim 2,
the sliding plate having a stopper for preventing the inner cable from slipping out, the stopper extending from the plate to come close to an outer circumference of the pulley.

9. The cable guide as defined in claim 3,
the sliding plate having a stopper for preventing the inner cable from slipping out, the stopper extending from the plate to come close to an outer circumference of the pulley.

10. The cable guide as defined in claim 4,
the sliding plate having a stopper for preventing the inner cable from slipping out, the stopper extending from the plate to come close to an outer circumference of the pulley.

11. The cable guide as defined in claim 5,
the sliding plate having a stopper for preventing the inner cable from slipping out, the stopper extending from the plate to come close to an outer circumference of the pulley.

12. The cable guide as defined claim 6,
the sliding plate having a stopper for preventing the inner cable from slipping out, the stopper extending from the plate to come close to an outer circumference of the pulley.

13. A sliding door drive mechanism, comprising:
the cable guide as defined in claim 1;
an inner cable for operating a sliding door of a car by being changed in direction by means of the cable guide;
a drum for winding and unwinding the inner cable; and
a driving motor for driving rotation of the drum via a reducer.
